(19) United States
(12) Patent Application Publication
(10) Pub. No.: US 2008/0090084 A1
(43) Pub. Date: Apr. 17, 2008

(54) Flame retardant resin composition for printed circuit board and printed circuit board using the same

(75) Inventors: Jae-Choon Cho, Suwon-si (KR); Myeong-Ho Hong, Suwon-si (KR); Seung-Hyun Ra, Seongnam-si (KR); Jung-Woo Lee, Gunpo-si (KR); Sang-Moon Lee, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/898,702

(22) Filed: Sep. 14, 2007

(30) Foreign Application Priority Data
Oct. 11, 2006 (KR) 10-2006-0098709

(51) Int. Cl. C09K 21/14; B32B 27/38

(52) U.S. Cl. 428/413; 252/609

(57) ABSTRACT

The present invention relates to a flame retardant resin composition for a printed circuit board and a printed circuit board using the same, in more detail, to a flame retardant resin composition which includes: (a) a complex epoxy resin (b) an amino triazine type curing agent; (c) a curing accelerator; and (d) an inorganic filler, so that the flame retardant resin composition not only can show an excellent thermal stability, an excellent mechanical strength and a suitability for the imprinting lithography method but also can improve the reliability of a substrate by reducing a thermal expansion ratio, and to a printed circuit board using the same.

### CROSS-REFERENCE TO RELATED APPLICATIONS

This application claims the benefit of Korean Patent Application No. 10-2006-0098709 filed on Oct. 11, 2006 with the Korean Intellectual Property Office, the contents of which are incorporated here by reference in their entirety.

### BACKGROUND

1. Technical Field

The present invention relates to a flame retardant resin composition, more particularly, to a flame retardant resin composition being used as an interlayer dielectric layer of a printed circuit board, especially, a multi-layer printed circuit board.

2. Description of the Related Art

Recently, in response to the trend for electronic devices with greater miniaturization, thinner shaping, and lighter weighting, the high density mounting is required. A method for forming a wiring pattern by using a conventional photo lithography type has a limit in forming a micro-wiring by the use of a photoresist, and has many troubles in processing. Recently, an imprinting lithographic method for forming a minute wiring pattern to the nano size has been proposed. In the imprinting lithographic method, a conventional insulating material with a fixed curing degree is made to the semi-hardened state, a pattern is formed by stamping as a seal is affixed, and a micro-pattern is formed by plating a conductive metal in the inside of the pattern. But in case of the imprinting lithographic method, there are some problems that a selection width of a curing degree is narrow so that a restriction is brought to the processing condition, it is difficult to fit the exact curing condition so that a transfer is not made, or a stamp has the problem of a releasing property so that the failure rate of a substrate is raised.

Generally, in case of a polymer material which is an insulating material used for a printed circuit board or a semiconductor mounting substrate, an inorganic filler is used in order to overcome a limit of resin property and to endow with a desired function. But in case an inorganic filler is contained in a circuit board with large amount, there are some problems that the brittleness of a substrate increases, the adhesive force between a resin and a conductive wire decreases, and thus the mobility at the semi-cured state decreases. Therefore, to control resin properties is needed in order to bring out desired properties by employing the inorganic filler and to be suitable for performing the imprinting process.

Moreover, the halogen compound such as bromine and chlorine was used conventionally in order to give the flame retardancy of a substrate. However, it is known that the halogen compound produces the harmful dioxin to the human body during the combustion, so that the use is restricted. Therefore, the technology development on providing the flame retardancy by using a non-halogen compound is currently under way.

### SUMMARY

The present invention solves the problems associated with the conventional technologies, in detail, provides a flame retardant resin composition not only which shows an excellent thermal stability, an excellent mechanical strength and a suitability for the imprinting lithography method but also which may improve the reliability of a substrate by reducing the thermal expansion, and a printed circuit board using the same.

Additional aspects and advantages of the present general inventive concept will be set forth in part in the description which follows and, in part, will be obvious from the description, or may be learned by practice of the general inventive concept.

One aspect of the present invention may provide a flame retardant resin composition for a printed circuit board including: (a) a complex epoxy resin including 5 to 20 parts by weight of a bisphenol A type epoxy resin with an average epoxy resin equivalent of 100 to 700, 30 to 60 parts by weight of a cresol novolac epoxy resin with an average epoxy resin equivalent of 100 to 600, 15 to 30 parts by weight a rubber-modified epoxy resin with an average epoxy resin equivalent of 100 to 500, and 5 to 20 parts by weight of a phosphorus type epoxy resin with an average epoxy resin equivalent of 400 to 800; (b) an amino triazine type curing agent; (c) a curing accelerator; and (d) an inorganic filler.

According to one embodiment of the present invention, the amino triazine type curing agent may be mixed in an equivalent ratio of 0.3 to 1.5 with respect to a total epoxy group equivalent of the complex epoxy resin. Here, more preferably the amino triazine type curing agent may be mixed in an equivalent ratio of 0.7.

According to another embodiment of the present invention, the curing accelerator may be an imidazole type compound, such as at least one selected from the group consisting of 2-ethyl-4methylimidazole, 1-(2-cyanoethyl)-2-alkylimidazole, 2-phenyl imidazole and a mixture thereof. Here, the curing accelerator may be added by 0.1 to 1 parts by weight on the basis of 100 parts by weight of the complex epoxy resin.

According to another embodiment of the present invention, the inorganic filler may be at least one inorganic material selected from the group consisting of barium titanium oxide, barium strontium titanate, titanium oxide, lead zirconium titanate, lead lanthanum zirconate titanate, lead magnesium niobate-lead titanate, silver, nickel, nickel-coated polymer sphere, gold-coated polymer sphere, tin solder, graphite, tantalum nitride, metal silicon nitride, carbon black, silica, clay and aluminum borate. Here, the inorganic filler may be added by 20 to 50 parts by weight on the basis of 100 parts by weight of the complex epoxy resin. Also, the inorganic filler may be surface-treated with a silane coupling agent, and may include spherical fillers of which the sizes are respectively different.

Another aspect of the present invention may provide a printed circuit board of which an insulating layer is formed by using the flame retardant resin composition.

### BRIEF DESCRIPTION OF THE DRAWINGS

FIG. 1 illustrates a TMA graph of a resin composition according to one embodiment of the present invention.

### DETAILED DESCRIPTION

Hereinafter, a flame retardant resin composition for a printed circuit board, and a printed circuit board which employs the flame retardant resin composition, will be explained in more detail.

The imprinting lithographic process is a method of forming a micro-pattern by transcribing a wiring pattern on a softened substrate by pressing a mold serving as a stamp with a proper pressure at a fixed temperature, and plating a conductive metal inside of the pattern along the transcribed wiring pattern. A semi-cured state (B-stage) manufacturing condition and a curing degree of an insulating material have a great effect on performing the imprinting lithographic process. Also the thermal expansion of a substrate needs to be similar to the thermal expansion of a conductive wire to the utmost, because a crack is generated between the substrate and the conductive wire, as the difference in the thermal expansion is big, which may further cause a bad effect on the reliability of the substrate. Thus, the present invention provides a flame retardant resin composition which is suitable for an imprinting process and reduces the thermal expansion of a conductive metal while of which the thermal stability and the mechanical property are maintained.

A flame retardant resin composition for a printed circuit board of the present invention may include (a) a complex epoxy resin including 5 to 20 parts by weight of a bisphenol A type epoxy resin with an average epoxy resin equivalent of 100 to 700, 30 to 60 parts by weight of a cresol novolac epoxy resin with an average epoxy resin equivalent of 100 to 600, 15 to 30 parts by weight of a rubber-modified epoxy resin with an average epoxy resin equivalent of 100 to 500, and 5 to 20 parts by weight a phosphorus type epoxy resin with an average epoxy resin equivalent of 400 to 800; (b) an amino triazine type curing agent; (c) a curing accelerator; and (d) an inorganic filler.

The complex epoxy resin according to the present invention is a epoxy resin which does not include a halogen and is composed with a bisphenol A type epoxy resin, a cresol novolac epoxy resin, a rubber-modified epoxy resin and a phosphorus type epoxy resin.

Here, an average epoxy resin equivalent of the bisphenol A type epoxy resin may be 100 to 700. It is not preferable if the average epoxy resin equivalent is less than 100, because it is difficult to obtain desired properties. Also it is not preferable if the average epoxy resin equivalent is more than 700 because it is difficult to dissolve in a solvent and to control due to a high melting point. Also, a content of the bisphenol A type epoxy resin may be 5 to 20 parts by weight in the complex epoxy resin. It is not preferable if the content of bisphenol A type epoxy resin is less than 5 parts by weight because the adhesive force with the wiring material is deteriorated. Also it is not preferable if the content of bisphenol A type epoxy resin is more than 20 parts by weight because the thermal property and the electrical property decrease. The resin may be used by dissolving in a mixed solvent of 2-methoxyethanol, methyl ethyl ketone (MEK), dimethyl formamide (DMF) and methyl cellosolve (MCS).

The cresol novolac epoxy resin can be used as an epoxy resin of the novolak type. This is because that a cured material with high heat resistance can be obtained and that the thermal stability of a formed substrate can be improved. An average epoxy resin equivalent of the cresol novolac epoxy resin may be 100 to 600 and a content of the cresol novolac epoxy resin may be 30 to 60 parts by weight in the complex epoxy resin. It is not preferable if the average epoxy resin equivalent is less than 100 because it is difficult to obtain desired properties. Also it is not preferable if the average epoxy resin equivalent is more than 600 because it is difficult to dissolve in a solvent and to control due to a high melting point. Also, it is not preferable if the content of the cresol novolac epoxy resin is less than 30 parts by weight because it is difficult to obtain desired properties. Also it is not preferable if the content of the cresol novolac epoxy resin is more than 60 parts by weights because the electrical and the mechanical property are lowered. The cresol novolac epoxy resin may be used by dissolving in a mixed solvent of 2-methoxyethanol, methyl ethyl ketone (MEK), dimethyl formamide (DMF) and methyl cellosolve (MCS).

The rubber-modified epoxy resin may be obtained by mixing DGEBA (diglycidyl ether of bisphenol A) and ATBN (amine terminated butadiene acrylonitrile copolymer), and its average epoxy resin equivalent may be 100 to 500. It is not preferable if the average epoxy resin equivalent is less than 100 because it is difficult to obtain desired properties. Also it is not preferable if the average epoxy resin equivalent is more than 500 because it is difficult to dissolve in a solvent and to control due to a high melting point. The content of the rubber-modified epoxy resin may be 15 to 30 parts per weight in the complex epoxy resin. It is not preferable if a content of the rubber-modified epoxy resin is less than 15 because desired properties cannot be obtained. Also it is not preferable if the content of the rubber-modified epoxy resin is more than 30 because an insulating material may be easily broken which further causes cracks. The resin may be used by dissolving in a mixed solvent of 2-methoxyethanol, methyl ethyl ketone (MEK), dimethyl formamide (DMF) and methyl cellosolve (MCS).

The phosphorus type epoxy resin shows excellent flame retardant and self-extinguishing property. The phosphorus type epoxy resin may be added in order to give a flame retardant property of a printed circuit board. And an environment-friendly flame retardant substrate can be obtained because halogen is not included in the flame retardant substrate. An average epoxy resin equivalent of the phosphorus type epoxy resin may be 400 to 800. It is not preferable if the average epoxy resin equivalent is less than 400 because desired properties are not obtained. Also it is not preferable if the average epoxy resin equivalent is less than 800 because it is difficult to dissolve in a solvent and to control due to a high melting point. The content of the phosphorus type epoxy resin may be 5 to 20 parts by weight in the complex epoxy resin. It is not preferable if the content of the phosphorus type epoxy resin is less than 5 parts by weight because it is difficult to obtain a flame retardant property. Also it is not preferable if the content of the phosphorus type epoxy resin is more than 20 parts by weight because electrical and mechanical properties decrease. The resin may be used by dissolving in a mixed solvent of 2-methoxyethanol, methyl ethyl ketone (MEK), dimethyl formamide (DMF) and methyl cellosolve (MCS).

The curing agent according to the present invention improves a thermal stability of an insulating material. By using an amino triazine type curing agent including a nitrogen-based compound in the present invention, a resin composition having an excellent flame retardany and a low thermal expansion can be obtained. A softening temperature of the curing agent may be 150 to 100° C., a content of nitrogen may be 10 to 30 weight percent, and a hydroxyl group equivalent may be 100 to 200.

According to another embodiment, an equivalent ratio of the amino triazine type curing agent may be 0.3 to 1.5 with respect to the total epoxy group equivalent of the complex epoxy resin, more preferably 0.7. If the amino triazine type curing agent is mixed within the range of the equivalent ratio, a curing degree of a cured insulating layer, in other words, of a substrate can be controlled to a desired extent and the thermal expansion of a substrate can be reduced to the utmost. It is not desirable if the equivalent ratio is less than 0.3 because a flame retardancy of a composition decreases. Also it is not desirable if the ratio is more than 1.5 because an adhesive property and magnetic field stability decrease.

The curing accelerator according to the present invention may be a imidazole type curing accelerator. Also the curing accelerator according to the present invention may be one selected from the group consisting of 2-ethyl-4methylimidazole, 1-(2-cyanoethyl)-2-alkylimidazole, 2-phenyl imidazole and a mixture thereof, but it is not limited to them. Here, the curing accelerator may be added by 0.1 to 1 parts by weight on the basis of 100 parts by weight of the complex epoxy resin. If the content of the curing accelerator is less than 0.1 parts by weight, the speed of curing can significantly decrease, the curing cannot be completed and a problem in releasing can be occurred in the imprinting process. Also, if the content of the curing accelerator is more than 1 part by weight, the fast curing is occurred so that a pattern may not be transferred in the imprinting process.

Additionally a content of the phosphorous flame retardant epoxy resin, of which the price is relatively high, can be lowered by adding a flame retardant adjuvant. The compound such as Al₂O₃ which additionally has a phosphorous can be used as the flame-retardant adjuvant.

The inorganic filler according to the present invention can be added in order to reinforce a mechanical strength of a cured material which is usually insufficient in a cured material including only epoxy resins, and may be any electric insulating material which is generally used. Examples of the inorganic filler may be at least one inorganic material selected from the group consisting of barium titanium oxide, barium strontium titanate, titanium oxide, lead zirconium titanate, lead lanthanum zirconate titanate, lead magnesium niobate-lead titanate, silver, nickel, nickel-coated polymer sphere, gold-coated polymer sphere, tin solder, graphite, tantalum nitride, metal silicon nitride, carbon black, silica, clay and aluminum borate, and is not limited to such examples set forth above.

Here, the inorganic filler may be added by 20 to 50 parts by weight on the basis of 100 parts by weight of the complex epoxy resin. It is not preferable if the content of the inorganic filler is less than 20 because it is difficult to obtain a desired mechanical property. Also it is not preferable if the content of the inorganic filler is more than 50 because the phase separation may occur.

The surface of the inorganic filler may be treated with a silane coupling agent in order to promote affinity to the epoxy resin by a chemical bonding. The silane coupling agent may be amino type, epoxy type, acryl type, vinyl type, or the like, but not limited to them. Moreover, the inorganic filler having a spherical shape and different size, may be used to increase flowability inside of the resin composition and thermal and mechanical properties by raising packing density after curing.

The flame retardant resin composition according to the present invention may be suitable for a variety of substrates with insulating layers including BGAs, for example, a flexible printed circuit board (FPCB), a rigid PCB, a rigid-flexible PCB, a built-up substrate, a FCBGA (Flip chip ball grid array) and a PBGA (plastic ball grid array).

Embodiments relating a flame retardant resin composition were set forth above, hereinafter, explanations will be given in greater detail with reference to specific examples, and the protection scope of the present invention is not restricted to the following example.

### EXAMPLE 1

A 85 weight % bisphenol A type epoxy resin (Kookdo chemistry, and YD-011) of 14.99 g (solvent: 2-methoxyethanol), a 85 weight % cresol novolac epoxy resin (Kookdo chemistry, YDCN-500-01P) of 73.33 g(solvent: 2-methoxyethanol), a rubber-modified epoxy resin (Kookdo chemistry, polydis 3615) of 10 g, a 85 weight % phosphorous type flame retardant epoxy resin (Kookdo chemistry, KDP-550MC65) of 37.48 g (solvent: 2-methoxyethanol), and a 66.7 weight % amino triazine type novolac curing agent (GUN EI Chemical Industry co., ltd, PS-6313) of 56.50 g (solvent: 2-methoxyethanol) were mixed, and the mixture was agitated with a rate of 300 rpm, at 90° C., for 1 hour. Subsequently, after adding a 70.93 g of spherical silica having a size distribution of 0.2 to 1.2 μm, the mixture was agitated with a rate of 400 rpm for 3 hours. After lowering the temperature of the mixture to room temperature, a 2-ethyl-4-methyl imidazole of 0.5 g was added and agitated for 30 minutes to provide an insulating material composition.

### COMPARATIVE EXAMPLE

Except using a 66.7 weight % phenol novolac curing agent of 76.90 g (solvent: 2-methoxyethanol) as a curing agent, the same process as the above-mentioned Example 1 was performed to provide an insulating material composition.

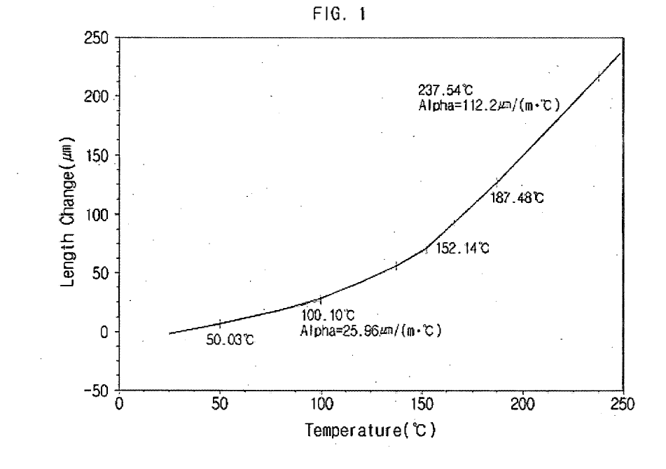

Each insulating material composition manufactured in Example 1 and Comparative Example was performed for film casting on a PET film, and completely cured by heat-treating at 90° C. for 30 minutes (Example 1), and 200° C. for 120 minutes (Comparative Example). Flame retardancy, Tg and CTE were measured by manufacturing dog-bone typed specimens. Measurement results were shown in the following table 1. Moreover, TMA result graph of the composition according to above mentioned Example 1 was shown in FIG. 1.

TABLE 1

| | flame retardant characteristic | | CTE |
|---|---|---|---|
| | (UL 94V) | Tg | (less than Tg) |
| example | V-0 | 160.61 | 27.58 |
| comparative | V-1 | 155.9 | 54.4 |
| example | | | |

### Measuring Method of Physical Property

1) flame retardancy measurement: according to UL 94 V (Vertical Burning Test) method, a sample was held perpendicularly and burned by a burner and the flame retardancy was rated as the V-2, V-1, V-0, 5V according to the extent of flaming combustion.

2) Tg and CTE measurement: Tg and CTE were measured by using the TMA Q 400 thermal analyzer of the TA Co, Ltd. Tg and CTE were measured at the temperature range of 25 to 250° C. with a heating speed of 10° C./min. Tg was adopted at the second scanning.

As shown in the table 1, it is noted that the the flame retardant composition of the present invention exhibits better flame retardancy compared to the conventional one because when the amino triazine type curing agent was used in the flame retardant composition of the present invention, the flame retardancy was rated as V-0, that is, the burning time of a sample is 10 seconds or less. It seems that the flame retardancy is additionally given by nitrogen contained in the amino triazine type curing agent. It is also noted that the flame retardant composition including the amino triazine type curing agent showed excellent CTE value in comparison with a flame retardant composition including the phenol novolac curing agent. It seems that NH groups in the curing agent besides OH groups reacting with the epoxy group are reacted additionally, so that a much denser structure of the cured material is formed.

It is apparent that the present invention is not limited to the embodiments set forth above and many of applications may be made by those skilled in the art without departing from the principle and spirit of the present invention, the scope of which is defined in the appended claims and their equivalents.

What is claimed is:

1. A flame retardant resin composition for a printed circuit board, the flame retardant resin composition comprising:
(a) a complex epoxy resin comprising 5 to 20 parts by weight of a bisphenol A type epoxy resin with an average epoxy resin equivalent of 100 to 700, 30 to 60 parts by weight of a cresol novolac epoxy resin with an average epoxy resin equivalent of 100 to 600, 15 to 30 parts by weight of a rubber-modified epoxy resin with an average epoxy resin equivalent of 100 to 500, and 5 to 20 parts by weight of a phosphorus type epoxy resin with an average epoxy resin equivalent of 400 to 800;
(b) an amino triazine type curing agent;
(c) a curing accelerator; and
(d) an inorganic filler.

2. The flame retardant resin composition of claim 1, wherein the amino triazine type curing agent is mixed in an equivalent ratio of 0.3 to 1.5 with respect to the total epoxy group equivalent of the complex epoxy resin.

3. The flame retardant resin composition of claim 1, wherein the curing accelerator is added by 0.1 to 1 parts by weight on the basis of 100 parts by weight of the complex epoxy resin.

4. The flame retardant resin composition of claim 1, wherein the inorganic filler is used by 20 to 50 parts by weight on the basis of 100 parts by weight of the complex epoxy resin.

5. The flame retardant resin composition of claim 1, wherein the curing accelerator is an imidazole type compound.

6. The flame retardant resin composition of claim 1, wherein the curing accelerator is at least one selected from the group consisting of 2-ethyl-4-methylimidazole, 1-(2-cyanoethyl)-2-alkylimidazole, 2-phenyl imidazole and a mixture thereof.

7. The flame retardant resin composition of claim 1, wherein the inorganic filler is at least one inorganic material selected from the group consisting of barium titanium oxide, barium strontium titanate, titanium oxide, lead zirconium titanate, lead lanthanum zirconate titanate, lead magnesium niobate-lead titanate, silver, nickel, nickel-coated polymer sphere, gold-coated polymer sphere, tin solder, graphite, tantalum nitride, metal silicon nitride, carbon black, silica, clay and aluminum borate.

8. The flame retardant resin composition of claim 1, wherein the inorganic filler is surface-treated with a silane coupling agent.

9. The flame retardant resin composition of claim 1, wherein the inorganic filler is in spherical shape of which size is different.

10. A printed circuit board, wherein an insulating layer is formed by using the flame retardant resin composition of claim 1.
